(19) United States
(12) Patent Application Publication
(10) Pub. No.: US 2014/0160671 A1
(43) Pub. Date: Jun. 12, 2014

(54) MOTHERBOARD COOLING SYSTEM

(71) Applicant: HON HAI PRECISION INDUSTRY CO., LTD., New Taipei (TW)

(72) Inventors: CHIH-HAO YANG, New Taipei (TW); LI-KAN YEH, New Taipei (TW)

(21) Appl. No.: 13/939,051

(22) Filed: Jul. 10, 2013

(30) Foreign Application Priority Data
Dec. 11, 2012 (TW) 101146750

(51) Int. Cl. G06F 1/20

(52) U.S. Cl. CPC G06F 1/20
USPC 361/679.47

(57) ABSTRACT

A motherboard cooling system includes a motherboard, a heat producing element, a fan module, a heat sink, a heat pipe, and a heat conducting plate. The heat conducting plate, the heat pipe, the heat sink, and the fan module cooperatively define an air path for airflow produced by the fan module to cool the heat producing element.

### BACKGROUND

1. Technical Field

The present disclosure relates to cooling systems, and particularly to a motherboard cooling system.

2. Description of Related Art

In an electronic device, such as an all-in-one computer, the monitor will contain a motherboard with a plurality of electronic components, such as a CPU, a fan, and a plurality of data storage devices crowded together in a small space that is difficult to cool. Thus, an improved cooling system is required in the crowded space.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a motherboard cooling system.

FIG. 2 is an isometric view of a heat conduct plate of the motherboard cooling system of FIG. 1.

FIG. 3 is an assembled, isometric view of the motherboard cooling system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

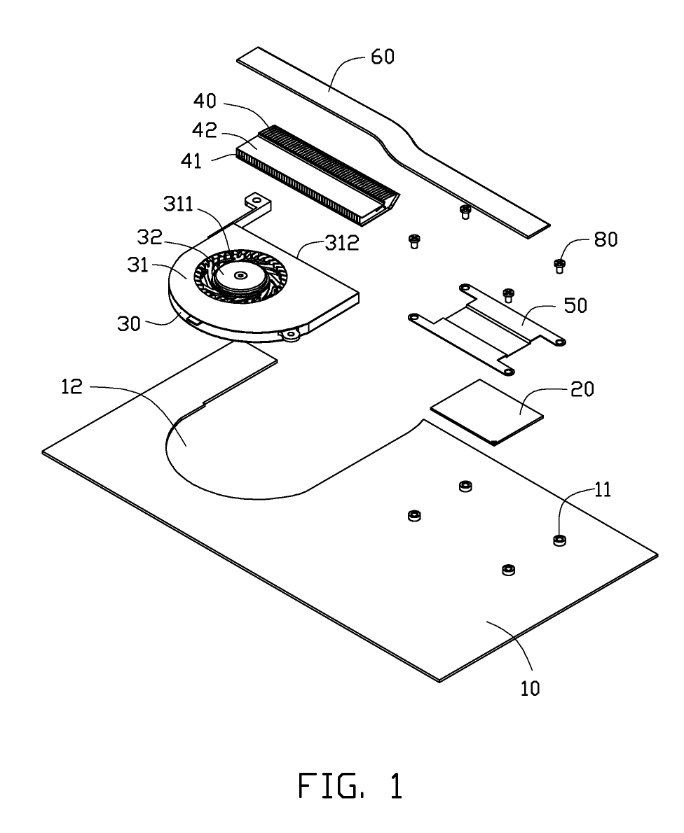

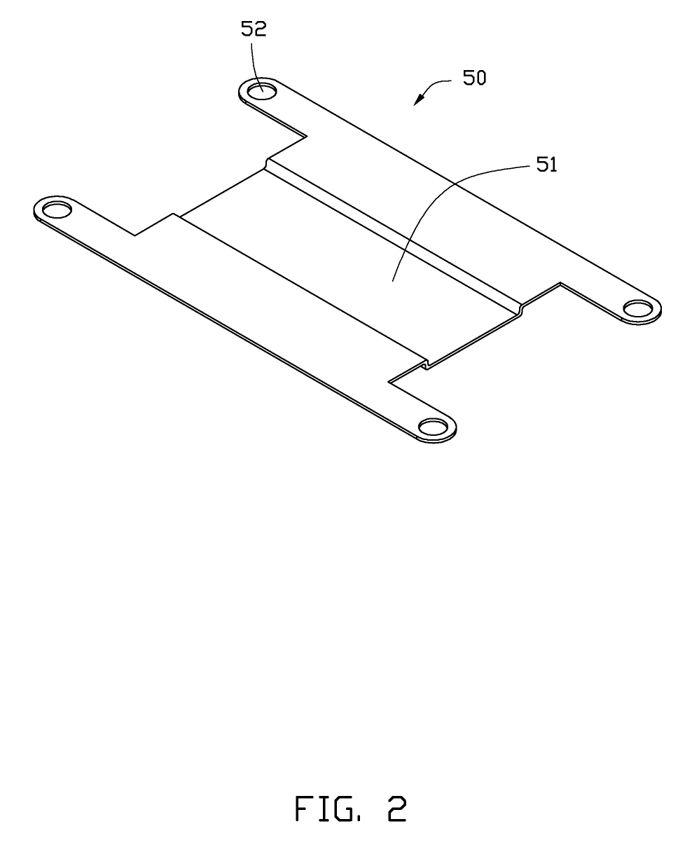

FIG. 1 and FIG. 2 show a motherboard cooling system in accordance with an embodiment. The motherboard cooling system includes a motherboard 10, a heat producing element 20 secured to the motherboard 10, a fan module 30, and a heat sink 40. In the illustrated embodiment, the element 20 is a CPU.

The motherboard 10 defines four installation holes 11 and a receiving opening 12. The receiving opening 12 is used for receiving the fan module 30 and the heat sink 40.

The fan module 30 includes a case 31 and a fan 32 mounted in the case 31. The case 31 defines an air inlet 311 and an air outlet 312. Air flows into the fan module 30 from the air inlet 311 along a first direction and flows out of air outlet 312 along a second direction. The first direction is substantially perpendicular to the second direction.

The heat sink 40 includes a plurality of fins 41 and defines a first installation slot 42 in top edges of the plurality of fins 41. In the illustrated embodiment, the first installation slot 42 is rectangular.

The motherboard cooling system further includes a heat conducting plate 50 and a heat pipe 60. The plate 50 defines a second installation slot 51 and four through holes 52 in four corners. In the illustrated embodiment, the second installation slot 51 is rectangular, and a cross-section of the heat pipe 60 is rectangular. Widths of the heat pipe 60, the first installation slot 42, and the second installation slot 51 are substantially equal. A height of the heat pipe 60 is substantially equal to the depths of the first installation slot 42 and the second installation slot 51.

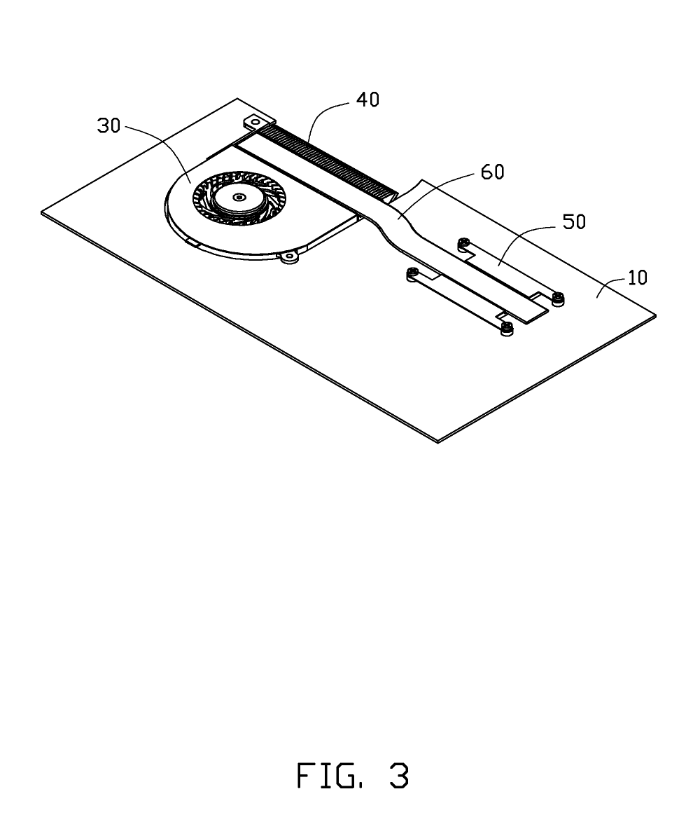

FIG. 1-3 show that, in assembly, the plate 50 is secured to the motherboard 10 using a plurality of locking members 80, such as screws, engaged in the through holes 52 and the installation holes 11. The plate 50 is located above the element 20, and a bottom wall of the second installation slot 51 abuts the element 20. The fan module 30 and the heat sink 40 are secured to the motherboard 10 and received in the receiving opening 12. The air outlet 312 faces the heat sink 40. A first end of the heat pipe 60 is soldered to the heat sink 40 and located in the first installation slot 42. A second end of the heat pipe 60 is soldered to the heating conduct plate 50 and located in the second installation slot 51. A top surface of the heat pipe 60 is exposed out of the heat sink 40 and the plate 50.

When the element 20 operates and generates heat, the heat is transferred to the fins 41 through the plate 50 and the heat pipe 60, and the fan module 30 operates to dissipate the heat from the heat sink 40. The rectangular second installation slot 51 increases contact area between the heat pipe 60 and the plate 50, for better heat transfer.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A motherboard cooling system comprising:
a motherboard;
a heating element secured to the motherboard;
a fan module secured to the motherboard;
a heat sink secured to the motherboard and defining a first installation slot;
a heat pipe; and
a heat conduct plate secured to the motherboard defining a second installation slot;
wherein a bottom wall of the second installation slot abuts the heating element; a first end of the heat pipe is mounted in the first installation slot, and a second end of the heat pipe is mounted in the second installation slot; and an air path is defined by the heat conduct plate, the heat pipe, the heat sink, and the fan module.

2. The motherboard cooling system of claim 1, wherein the second installation slot is rectangular.

3. The motherboard cooling system of claim 2, wherein a cross-section of the heat pipe is rectangular, and a width of the heat pipe is substantially equal to a width of the second installation slot.

4. The motherboard cooling system of claim 3, wherein a depth of the second installation slot is substantially equal to a height of the heat pipe.

5. The motherboard cooling system of claim 4, wherein the first installation slot is rectangular, the width of the heat pipe is substantially equal to a width of the first installation slot, and a depth of the first installation slot is substantially equal to the height of the heat pipe.

6. The motherboard cooling system of claim 1, wherein a top surface of the heat pipe is exposed out of the heat sink and the heat conduct plate.

7. The motherboard cooling system of claim 1, wherein the fan module comprises a case and a fan mounted in the case; the case defines an air inlet and an air outlet, and the air outlet faces the heat sink; air flows into the fan module from the air inlet along a first direction and flows out of the air outlet along a second direction, and the first direction is substantially perpendicular to the second direction.

8. The motherboard cooling system of claim 1, wherein the heat sink comprises a plurality of fins, and the first installation slot extends from top edges of the plurality of fins.

9. A motherboard cooling system comprising:
a motherboard;
a heating element secured to the motherboard;
a fan module secured to the motherboard;
a heat sink secured to the motherboard and defining a first installation slot;
a heat pipe; and
a heat conduct plate secured to the motherboard defining a second installation slot;
wherein a first end of the heat pipe is mounted in the first installation slot, and a second end of the heat pipe is mounted in the second installation slot; and an air path is defined by the heat conduct plate, the heat pipe, the heat sink, and the fan module; the second installation slot is rectangular, a cross-section of the heat pipe is rectangular, and a width of the heat pipe is substantially equal to a width of the second installation slot.

10. The motherboard cooling system of claim 9, wherein a bottom wall of the second installation slot abuts the heating element.

11. The motherboard cooling system of claim 9, wherein a depth of the second installation slot is substantially equal to a height of the heat pipe.

12. The motherboard cooling system of claim 9, wherein the first installation slot is rectangular, the width of the heat pipe is substantially equal to a width of the first installation slot, and a depth of the first installation slot is substantially equal to the height of the heat pipe.

13. The motherboard cooling system of claim 9, wherein a top surface of the heat pipe is exposed out of the heat sink and the heat conduct plate.

14. The motherboard cooling system of claim 9, wherein the fan module comprises a case and a fan mounted in the case; the case defines an air inlet and an air outlet, and the air outlet faces the heat sink; air flows into the fan module from the air inlet along a first direction and flows out of the air outlet along a second direction, and the first direction is substantially perpendicular to the second direction.

15. The motherboard cooling system of claim 9, wherein the heat sink comprises a plurality of fins, and the first installation slot extends from top edges of the plurality of fins.
